(19) United States
(12) Patent Application Publication
(10) Pub. No.: US 2024/0096204 A1
(43) Pub. Date: Mar. 21, 2024

(54) VEHICLE SMOKE DETECTION SYSTEM AND METHOD THEREFOR

(71) Applicant: Keyfree Technologies Inc., Etobicok (CA)

(72) Inventors: Howard B. KATZ, Boca Raton, FL (US); Roman GOLD, Toronto (CA); Tony ALBERGA, Toronto (CA)

(21) Appl. No.: 18/127,339

(22) Filed: Mar. 28, 2023

Related U.S. Application Data
(63) Continuation-in-part of application No. 17/948,077, filed on Sep. 19, 2022, now abandoned.

(51) Int. Cl. G08B 29/04; G08B 17/10; G08B 25/10

(52) U.S. Cl. CPC G08B 29/046; G08B 17/10; G08B 25/10; G08B 29/043

(57) ABSTRACT

A smoke detecting system for an interior of a vehicle has a smoke detecting dongle removably attached to an OnBoard Diagnostic II (OBD-II) port of the vehicle within the interior of the vehicle. The smoke detecting dongle monitors smoke detected within the interior of the vehicle to determine when tobacco or cannabis smoke is detected. A locking device is coupled to the smoke detecting dongle preventing unauthorized removal of the smoke detecting dongle from the OBD-II port. The smoke detecting dongle wirelessly transmits an alarm signal when the smoke detecting dongle is removed from the OBD-II port without unlocking the locking device.

### RELATED APPLICATIONS

This patent application is a Continuation-In-Part (CIP) of U.S. patent application Ser. No. 17/948,077, filed Sep. 19, 2022, entitled “VEHICLE SMOKE DETECTION SYSTEM AND METHOD THEREFOR”, IN THE NAMES OF Howard B. Katz, Roman Gold and Tony Alberga, which is related to U.S. patent application Ser. No. 17/138,598 filed Dec. 20, 2020, entitled “VEHICLE SMOKE DETECTION SYSTEM AND METHOD THEREFOR”, in the name of Howard Katz, and which all are incorporated herein by reference in their entirety.

### TECHNICAL FIELD

The present application in general relates to a smoke detection system, and more specifically, to a dongle which may be connected to an On-Board Diagnostic II (OBD II) port of a vehicle to monitor and record any smoke within the interior of the vehicle and to distinguish between tobacco smoke and cannabis smoke.

### BACKGROUND

Smoking has become less and less tolerated in all areas of everyday life. The changing attitude may also be reflected in the way car companies look at smoking. These days, many car companies have changed cigarette lighters into power sockets. In fact, many car companies may charge the client extra if a cigarette lighter is requested. Car companies have also replaced the ashtray with a coin holder or other types of storage compartments.

In a study funded by an anti-tobacco group, it was found that 4000 chemicals may be found in secondhand smoke. The study also found that the nicotine levels may be 30 times higher in smoker's cars than ones which are tobacco free. It may be for these reasons that more than 90 percent of non-smokers ban any sort of tobacco, cannabis and/or vaping ignition in their cars. When tobacco, cannabis and/or vaping is smoked in the enclosed environments of passenger cars, air concentrations of smoke pollutants can become extremely high. Many of the pollutants may attach to surfaces and accumulate in duster from where they can be released back into the air over days and weeks after smoking.

Because of the damage cigarette, cannabis and/or vaping smoke may do to the interior of a vehicle, automobiles sold by smokers and automobiles that had been smoked in are generally offered at a significantly lower prices than equivalent cars offered by nonsmokers and in which no smoking was reported. Studies have shown that the value of the automobile decreases by 7.5% if the automobile was sold by a smoker compared to an equivalent car sold by a nonsmoker.

Because of the damage cigarette and other smoking articles smoke may do to the interior of a vehicle, many rental car companies as well as companies that provide vehicles to their employees may limit and/or prohibit smoking in the vehicles. However, many times, individuals fail to obey company policy and may still smoke inside the vehicle. When an individual does smoke in a rental and/or company vehicle, it may be difficult to determine which individual may be responsible for the smoke damage as the individual may place blame on the previous driver. Presently, there is no device that may register that smoking did occur within a vehicle while an individual has rented and/or is responsible for the vehicle.

Most vehicles do not have any type of smoke detecting systems. Unfortunately, to retrofit an existing vehicle may be extremely costly as well as time consuming. Further, when a vehicle is taken out of commission to retrofit the vehicle with a smoke detecting system, the vehicle is generally out of commission and thus the rental car company and/or car service company cannot use the vehicle to generate income.

Vehicle owners may also want to know if the individual driving the vehicle may have been impaired while driving. Driving while impaired by any substance is dangerous. The delta-9-tetrahydrocannabinol (THC) contained in marijuana is a psychoactive (mind-altering) compound that may affect areas of the brain that control the body's movements, balance, coordination, memory, and judgment. It can impair coordination, distort perception, and lead to memory loss and difficulty in problem-solving. Specific to driving, THC can slow reaction times and reduce the ability to make decisions.

Therefore, it would be desirable to provide a system and method that overcomes the above. The system and method would provide a smoke detecting device that may be easily inserted into a vehicle's computer to monitor an interior of the vehicle for smoke and to distinguish between tobacco smoke and cannabis smoke.

### SUMMARY

In accordance with one embodiment, a smoke detecting system for an interior of a vehicle is disclosed. The smoke detecting system has a smoke detecting dongle removably attached to an OnBoard Diagnostic II (OBD-II) port of the vehicle within the interior of the vehicle. The smoke detecting dongle monitors smoke detected within the interior of the vehicle to determine when tobacco or cannabis smoke is detected. A locking device is coupled to the smoke detecting dongle preventing unauthorized removal of the smoke detecting dongle from the OBD-II port. The smoke detecting dongle wirelessly transmits an alarm signal when the smoke detecting dongle is removed from the OBD-II port without unlocking the locking device.

In accordance with one embodiment, a smoke detecting system for an interior of a vehicle is disclosed. The smoke detecting system has a smoke detecting dongle removably attached to an OnBoard Diagnostic II (OBD-II) port of the vehicle within the interior of the vehicle. The smoke detecting dongle monitors smoke detected within the interior of the vehicle to determine when tobacco or cannabis smoke is detected. A locking device is coupled to the smoke detecting dongle preventing unauthorized removal of the smoke detecting dongle from the OBD-II port. The smoke detecting dongle has at least one sensor. A microcontroller unit (MCU) is coupled to the at least one sensor determining when the at least one sensor detects the cannabis smoke within the interior of the vehicle above a predetermined threshold. A memory device is coupled to the MCU. A receiver/transmitter is coupled to the MCU. An alarm sensor is coupled to the locking device, the alarm sensor sending a signal when the smoke detecting dongle is removed from the OBD-II port without unlocking the locking device.

In accordance with one embodiment, a smoke detecting system for an interior of a vehicle is disclosed. The smoke detecting system has A smoke detecting dongle removably attached to an OnBoard Diagnostic II (OBD-II) port of the vehicle within the interior of the vehicle. The smoke detecting dongle monitors smoke detected within the interior of the vehicle to determine when cannabis smoke is detected. A locking device is coupled to the smoke detecting dongle preventing unauthorized removal of the smoke detecting dongle from the OBD-II port. The smoke detecting dongle has a multi-pin connector attaching the dongle to the OBD-II port. At least sensor, wherein the at least one sensor is an electrochemical sensor. A microcontroller unit (MCU) is coupled to the at least one sensor determining when the at least one sensor detects the cannabis smoke within the interior of the vehicle above a predetermined threshold. A memory device is coupled to the MCU. A receiver/transmitter is coupled to the MCU. An alarm sensor is coupled to the locking device. The alarm sensor sends a signal when the smoke detecting dongle is removed from the OBD-II port without unlocking the locking device. A Global Positioning System (GPS) module is coupled to the MCU, the GPS module indicating a current location of the smoke detecting dongle.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a simplified diagram of an exemplary vehicle smoke detecting system according to one aspect of the present application;

FIG. 2 is a schematic view of an exemplary smoke detecting dongle used in the system depicted in FIG. 1 in accordance with one aspect of the present application;

FIG. 3 is a block diagram of an exemplary smoke detecting dongle of the system depicted in FIG. 1 in accordance with one aspect of the present application; and

FIG. 4 is a diagram showing an exemplary operation of the smoke detecting system depicted in FIG. 1 in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method relate to a vehicle smoke detection system. The vehicle smoke detection system may continuously monitor a vehicle for the detection of smoke particles. The logged information may include a time, a location, and distinguishes whether the smoke detected is tobacco smoke or cannabis smoke. The data logged by the vehicle smoke detection system may be downloaded by an owner of the vehicle. The downloaded information may be used by the owner of the vehicle to charge the user of the vehicle for smoking violations within the vehicle.

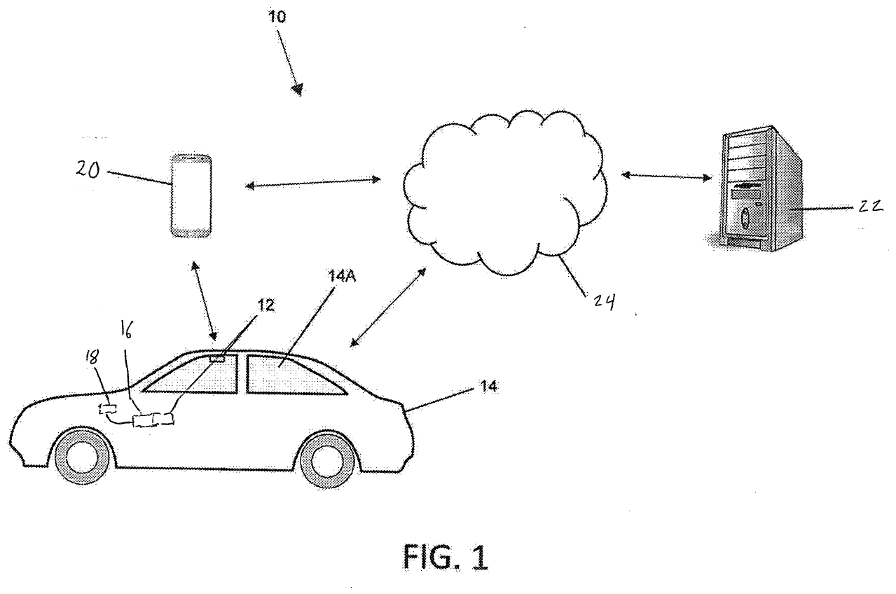

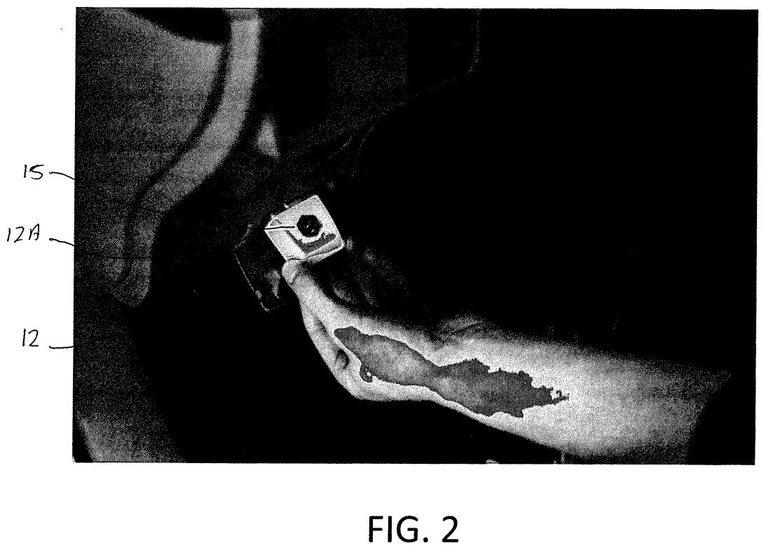

Referring now to FIGS. 1 and 2, a vehicle smoke detection system 10 (hereinafter system 10) may be disclosed. The system 10 may be used by any owner of a vehicle 14 who may wish to monitor whether users of the vehicle 14 have been smoking inside the vehicle 14. More specifically, the system 10 may be used by owners of a fleet of vehicles 14, who may wish to monitor whether users of the vehicle 14 are smoking inside the vehicle 14, such as car rental agencies, companies that provide employees with company vehicles, law enforcement departments, car sharing operations, trucking companies and the like. The above listing is given as an example and should not be seen in a limiting manner.

The system 10 may have a smoke monitoring dongle 12 (hereinafter dongle 12). The dongle 12 may be installed within an interior 14A of the vehicle 14. In accordance with one embodiment, the dongle 12 may be connected to an On-Board Diagnostic II (OBD-II) port 16 of the vehicle 14. The OBD-II port 16 may be used to access an onboard computer 18 of the vehicle 14 that may monitor multiple systems of the vehicle 14 such as, but not limited to: emissions, mileage, speed, location, as well as other data. In accordance with one embodiment, the dongle 12 may have a multi-pin connector 12A which may be inserted into a pinout port of the OBD-II port 16. Presently, current OBD-II ports 16 may have 16 pinout ports with port 4 being battery ground and port 16 being battery positive.

The dongle 12 may be removably connected to the On-Board Diagnostic II (OBD-II) port 16. Thus, the dongle 12 may be portable and allows the dongle 12 to be placed in different vehicles 14. This allows the system 10 to be a portable vehicle smoke detecting system. In order to prevent non-owners of the vehicle 14 from removing the dongle 12, a locking device 15 may be formed on the dongle 12. Once the dongle 12 is attached to the OBD-II port 16, the locking device 15 may be engaged to secure the dongle 12 to the OBD-II port 16 and prevent unauthorized individuals from removing/disengaging the dongle 12 from the OBD-II ports 16. The locking device 12 may be a key lock or similar device that may allow only authorized individuals to disengage the dongle 12 from the OBD-II port 16. In accordance with embodiment, the owner of the vehicle 14 may be notified if the dongle 12 is removed and may charge a penalty to the driver if removed as described below.

When the dongle 12 is connected to the OBD-II ports 16, the dongle 12 may connect to the onboard computer 18 of the vehicle 14. The dongle 12 may monitor the interior 14A of the vehicle 14 for smoke. If the monitored value of smoke detected exceeds a predetermined value, the dongle 12 may record a date and time of the occurrence. The predetermined value may be set to any level. This may allow the dongle 12 to prevent false detection of smoke. For example, a higher setting may prevent the dongle 12 from recording the occurrence of smoke detection when there may be smoke outside of the vehicle 14 but the windows of the vehicle 14 may be down. Thus, occurrences such as second-hand smoke from people outside of the vehicle 14, smoke from grills/fireplaces, and the like should not be sufficient to cause the dongle 12 to record a date and time of the occurrence.

As will be described below, the dongle 12 may be able to analyze the smoke detected and distinguish between different types of smoke. For example, the dongle 12 may be able distinguish between tobacco smoke and cannabis smoke. The determination of the type of smoke may be performed by a remote server 22 or by components of the dongle 12 as may be described below. When a user returns the vehicle 14 to the owner, the owner may use a computing device 20 to download data from the dongle 12. The computing device 20 may be a personal computer system, tablet device, handheld or laptop device, mobile phone device, server computer system, multiprocessor system, microprocessor-based system, set top boxes, programmable consumer electronics, network PCs, and distributed cloud computing environments that include any of the above systems or devices, and the like.

The data monitored and recorded by the dongle 12 may be downloaded to the computing device 20 via wire or wireless means. For example, the computing device 20 may be plugged into the dongle 12. Alternatively, or in addition to, the computing device 20 may download the data wirelessly from the dongle 12. The computing device 20 may download the data wirelessly using a Personal Area Network (PAN) using wireless technologies such as, but not limited to, ANT+, Bluetooth, IEEE 802.15 TG3, IEEE 802.15 TG4, or similar standards.

The computing device 20 may upload the data to a server 22 for storage and/or analysis of the data. The computing device 20 may connect to a network 24. The network 24 may be a local area network (LAN), a general wide area network (WAN), wireless local area network (WLAN) and/or a public network. Once connected to the network 24, the computing device 20 may upload and transfer the data to the server 22 via the network 24. Once the computing device 20 has downloaded the data from the dongle 12 to the server 22, the downloaded data may be used by the owner to charge the user of the vehicle 14 for smoking violations in the vehicle 14.

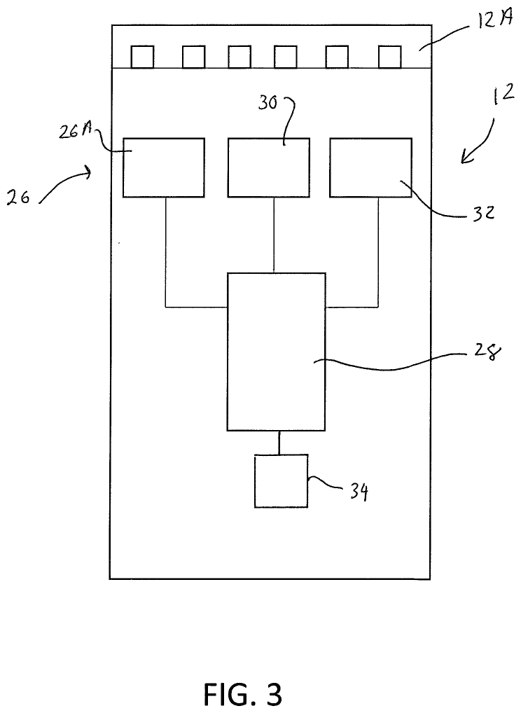

Referring to FIGS. 1-3, the dongle 12 may be disclosed in further details. The dongle 12 may have one or more smoke detecting sensors 26. Different types of technologies may be used for the smoke detecting sensor 26. In accordance with one embodiment, the smoke detecting sensor 26 is a particle sensor 26A. The particle sensor 26A may be a high-precision particle concentration sensor based on Mie scattering theory. Mie scattering theory is a generalized solution that describes the scattering of an electromagnetic wave by a homogeneous spherical medium having refractive indexes (RIs) different from that of the medium through which the wave is traversing. The particle sensor 26A may support the continuous acquisition of data and calculates the number of suspended particles, different sizes of the particle in the air per unit volume and converts this data into an air quality concentration levels. In accordance with one embodiment, the particle sensor 26A can detect particle sizes from 0.1 μM to 10 μM. Tobacco and cannabis smoke particles are quantitatively similar in volatility, shape, density and number concentration, albeit with differences in size, total mass and chemical composition. By determining the size of the suspended particle, one may determine whether the smoke detected is tobacco or cannabis. Particles from cannabis smoke are on average 29% larger in mobility diameter than particles from tobacco smoke and contain 3.4× more total mass. Alternatively, the sensor 26 may be an electrochemical sensor 26B. The electrochemical sensor 26B may be designed to detect and distinguish between different chemical compounds in the smoke being detected. Thus, the data electrochemical sensor 26B may be used to determine if the smoke detected contains tobacco or cannabis.

The sensor 26 may be coupled to a microcontroller unit (MCU) 28 of the dongle 12. The sensor 26 may be coupled to the MCU 28 through a digital serial interface. The data monitored from the sensor 26 may be transferred in frames of 28 bytes plus framing and checksum bytes. The MCU 28 may monitor the data from the sensor 26 at predetermined timeframes. For example, the MCU 28 may monitor the data from the sensor 26 every 5 seconds.

Using the data from the sensor 26, the MCU 28 may process the data using adjustable thresholds to determine if a recordable “smoke event” has occurred. A “smoke event” may occur when the data being monitored exceeds a predetermined value, and if the absolute difference between the event and the last recorded event exceeds a change threshold. If the MCU 28 determines that the monitored value of particulates exceeds a predetermined value, the MCU 28 may record a time/date of the reading and store this in a memory 30 of the dongle 12. The MCU 28 may further analyze the data monitored by the sensor 26. The MCU 28 may analyze the date as disclosed above to determine whether the smoke detected is contains tobacco or cannabis particles.

The dongle 12 may have a Global Positioning System (GPS) module 34 coupled to the MCU 28. The GPS module 34 may be used to track a location of the vehicle 14. Thus, when the dongle 12 detects that a “smoke event” that exceeds a predetermined value has occurred, the GPS module 34 may record a location of the “smoke event” and store it in the memory 30. Alternatively, if the vehicle 14 has a GPS unit coupled to the onboard computer 18 of the vehicle 14, the GPS unit of the vehicle 14 may be used to monitor the location of the “smoke event” and record and store this location in the memory 30. The memory 30 may be a separate memory device and/or a memory unit of the MCU 28.

In accordance with one embodiment, since the dongle 12 may have a GPS module 34, the dongle 12 may be used as a tracking device/anti-theft device. The owner of the vehicle 14 may log into the system 10 in order to track/monitor the location of the vehicle 14. Thus, if the vehicle 14 is not returned when scheduled, stolen, or not in a permitted location (i.e., taken out of the country or the like), the owner of the vehicle 14 may log into the system 10 in order to track/monitor the location of the vehicle 14.

In accordance with one embodiment, smoke events may be time stamped and saved to the memory 30 if the average particle count exceeds a baseline threshold, and if the absolute difference between the event and the last recorded event exceeds a change threshold. Further, in accordance with one embodiment, the last recorded event may have to be within a predetermined timeframe otherwise the change threshold may be set to zero so that the smoke event, when the average particle count exceeds the baseline threshold, is recorded.

Tobacco and cannabis smoke particles are quantitatively similar in volatility, shape, density and number concentration, albeit with differences in size, total mass and chemical composition. Particles from cannabis smoke are on average 29% larger in mobility diameter than particles from tobacco smoke and contain 3.4× more total mass. Thus, based on the difference in size of the particles being monitored by the particle sensor 26A, one may be able to determine if the smoke detected by the particle sensor 26A is tobacco smoke or cannabis smoke. This determination may be done by the MCU 28 or alternatively by the server 22.

The dongle 12 may have a wireless transmitter/receiver 32. The wireless transmitter/receiver 32 may allow the wireless transmission of data to and from the dongle 12. The receiver/transmitter 32 may be used to wirelessly transmit data stored in the memory 30 to the computing device 20 in different manners. The data transmitted by the wireless transmitter/receiver 32 may be encrypted. Encryption may secure the data by encoding it mathematically through cryptography so that it can only be read, or decrypted, by those with the correct key or password. The dongle 12 may use symmetric or asymmetric encryption.

In accordance with one embodiment, the computing device 20 may need to be within a short range of the receiver/transmitter 32. The computing device 16 may then download the data wirelessly using a Personal Area Network (PAN) using wireless technologies such as, but not limited to, ANT+, Bluetooth, IEEE 802.15 TG3, IEEE 802.15 TG4, or similar standards.

Alternatively, or in addition to, the wireless transmitter/receiver 32 may be a long range receiver/transmitter 32. The long range receiver/transmitter 32 may use a cellular network, or satellite communications to transmit data/messages to the owner of the vehicle 14. Using a long range transmitter that uses a cellular or satellite network may allow the dongle 10 to transmit data in real time. Thus, messages may be sent to the owner in real time such as when a smoke event has occurred, when the dongle 12 has been tampered with, and similar events.

The data transferred to the computing device 20 can be transmitted to the server 22 via the network 24. The network 24 may be a local area network (LAN), a general wide area network (WAN), wireless local area network (WLAN) and/or a public network. Once connected to the network 24, the computing device 20 may transmit the data to the server 22. Since the data may consists of particle counts, as well as particle concentrations, for different particle sizes, the server 22 may analyze the data transmitted to determine the type of particles that have been detected and conclude the presence of cannabis smoke or cigarette smoke. Through collection of detected smoke data the server 22 may calculate the probability of cannabis smoking inside the vehicle 14. The server 22 may transmit this data to the owner of the vehicle 14 via email, text, and/or other similar notification methods in real time.

The dongle 12 may have an alarm sensor 34. The alarm sensor 34 may be used to determine when the dongle 12 is disconnected from the vehicle 14. If an unauthorized removal of the dongle 12 is detected, the alarm sensor 34 may send a signal to the wireless transmitter/receiver 32 alerting the owner of the vehicle 14. The owner may then charge a penalty to the driver for the unauthorized removal of the dongle 12. In accordance with one embodiment, the alarm sensor may be coupled to the locking device 15. In this embodiment, when the locking device 15 is disconnected/unlocked, the alarm sensor 34 may also be deactivated. This may allow a user of the dongle 12 to remove the dongle 12 without setting off the alarm sensor 34.

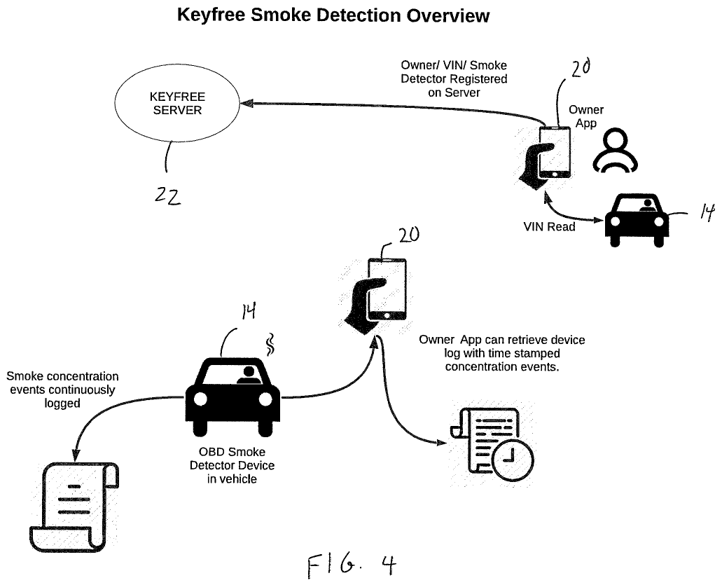

Referring to FIGS. 1-4, operation of the system 10 may be disclosed. When the ignition of the vehicle 14 is started by a user, the dongle 12 may be activated and may begin to determine the presence of smoke within the interior 14A of the vehicle 14. The dongle 12 may be programed so that the smoke detecting sensors 26 takes air samples continuously to determine the presence of smoke within the interior 14A of the vehicle 14 or alternatively may be programmed to take air samples within the interior 14A of the vehicle 14 at predetermines intervals, such as every 5 secs or the like.

When the smoke detecting sensors 22 is active and monitoring the interior of the vehicle 14, readings from the smoke detecting sensors 26 may be stored in the memory 30 of the dongle 12. The memory 30 may log all qualifying smoke events. Data stored in the memory 30 may be transferred to the computing device 20. The data stored in the memory 30 may be transferred to the computing device 20 by a wired connection or wirelessly. The computing device 20 may download the data wirelessly using a Personal Area Network (PAN) using wireless technologies such as, but not limited to, ANT+, Bluetooth, IEEE 802.15 TG3, IEEE 802.15 TG4, or similar standards.

The computing device 20 may transfer the data from the dongle 12 to the server 22 via the network 24. The network 24 may be a local area network (LAN), a general wide area network (WAN), wireless local area network (WLAN) and/or a public network. The server 22 may then transmit this data to the owner of the vehicle 14 and/or the computing device 16. The server 22 may transmit this data to the owner of the vehicle 14 via email, text, and/or other similar notification methods. The data transmitted may be the time/date of the event, the level of the smoke detected, type of smoke detected, and similar information. Based on this information, the owner of the vehicle 14 may charge the user of the vehicle 14 for violating the terms of the rental/user agreement.

The foregoing description is illustrative of particular embodiments of the invention, but is not meant to be a limitation upon the practice thereof. The following claims, including all equivalents thereof, are intended to define the scope of the invention.

What is claimed is:

1. A smoke detecting system for an interior of a vehicle, comprising:
a smoke detecting dongle removably attached to an OnBoard Diagnostic II (OBD-II) port of the vehicle within the interior of the vehicle, the smoke detecting dongle monitoring smoke detected within the interior of the vehicle to determine when tobacco or cannabis smoke is detected;
a locking device coupled to the smoke detecting dongle preventing unauthorized removal of the smoke detecting dongle from the OBD-II port;
wherein the smoke detecting dongle wirelessly transmits an alarm signal when the smoke detecting dongle is removed from the OBD-II port without unlocking the locking device.

2. The system of claim 1, wherein the smoke detecting dongle comprises:
at least one sensor; and
a microcontroller unit (MCU) coupled to the at least one sensor determining when the at least one sensor detects smoke within the interior of the vehicle above a predetermined threshold smoke level.

3. The system of claim 2, wherein the smoke detecting dongle comprises a memory device coupled to the MCU.

4. The system of claim 2, wherein the smoke detecting dongle comprises a receiver/transmitter coupled to the MCU.

5. The system of claim 4, wherein the receiver/transmitter wirelessly transmits data using one of ANT+, Bluetooth, IEEE 802.15 TG3, IEEE 802.15 TG4, or similar standards.

6. The system of claim 2, wherein the smoke detecting dongle comprises a multi-pin connector attaching the smoke detecting dongle to the OBD-II port.

7. The system of claim 2, wherein the smoke detecting dongle comprises an alarm sensor coupled to the locking device, the alarm sensor sending a signal when the smoke detecting dongle is removed from the OBD-II port without unlocking the locking device.

8. The system of claim 2, wherein the at least one sensor is a particle sensor.

9. The system of claim 2, wherein the at least one sensor is an electrochemical sensor.

10. The system of claim 2, wherein the MCU records a time and day the at least one sensor detects smoke within the interior of the vehicle above the predetermined threshold smoke level.

11. The system of claim 1, wherein the smoke detecting system comprises a server, wherein data of the smoke detected is transferred to the server to determine if the smoke detected is cannabis smoke.

12. A smoke detecting system for an interior of a vehicle, comprising:
a smoke detecting dongle removably attached to an OnBoard Diagnostic II (OBD-II) port of the vehicle within the interior of the vehicle, the smoke detecting dongle monitoring smoke detected within the interior of the vehicle to determine when tobacco or cannabis smoke is detected; and
a locking device coupled to the smoke detecting dongle preventing unauthorized removal of the smoke detecting dongle from the OBD-II port;
wherein the smoke detecting dongle comprises:
at least one sensor;
a microcontroller unit (MCU) coupled to the at least one sensor determining when the at least one sensor detects the tobacco or cannabis smoke within the interior of the vehicle above a predetermined threshold;
a memory device coupled to the MCU;
a receiver/transmitter coupled to the MCU; and
an alarm sensor coupled to the locking device, the alarm sensor sending a signal when the smoke detecting dongle is removed from the OBD-II port without unlocking the locking device.

13. The system of claim 12, wherein the smoke detecting dongle comprises a Global Positioning System (GPS) module coupled to the MCU, the GPS module indicating a current location of the smoke detecting dongle.

14. The system of claim 12, wherein the receiver/transmitter wirelessly transmits data using one of ANT+, Bluetooth, IEEE 802.15 TG3, IEEE 802.15 TG4, or similar standards.

15. The system of claim 12, wherein the smoke detecting dongle comprises a multi-pin connector attaching the dongle to the OBD-II port.

16. The system of claim 12, wherein the at least one sensor is a particle sensor.

17. The system of claim 12, wherein the at least one sensor is an electrochemical sensor.

18. The system of claim 12, wherein the MCU records a time and day the at least one sensor detects cannabis smoke within the interior of the vehicle above the predetermined threshold.

19. The system of claim 12, wherein the smoke detecting system comprises a server, wherein data of the smoke detected is transferred to the server to determine if the smoke detected is cannabis smoke.

20. A smoke detecting system for an interior of a vehicle, comprising:
a smoke detecting dongle removably attached to an OnBoard Diagnostic II (OBD-II) port of the vehicle within the interior of the vehicle, the smoke detecting dongle monitoring smoke detected within the interior of the vehicle to determine when tobacco or cannabis smoke is detected; and
a locking device coupled to the smoke detecting dongle preventing unauthorized removal of the smoke detecting dongle from the OBD-II port;
wherein the smoke detecting dongle comprises:
a multi-pin connector attaching the dongle to the OBD-II port;
at least one sensor, wherein the at least one sensor is an electrochemical sensor;
a microcontroller unit (MCU) coupled to the at least one sensor determining when the at least one sensor detects the tobacco or cannabis smoke within the interior of the vehicle above a predetermined threshold;
a memory device coupled to the MCU;
a receiver/transmitter coupled to the MCU;
an alarm sensor coupled to the locking device, the alarm sensor sending a signal when the smoke detecting dongle is removed from the OBD-II port without unlocking the locking device;
a Global Positioning System (GPS) module coupled to the MCU, the GPS module indicating a current location of the smoke detecting dongle.
